(19) United States
(12) Patent Application Publication
(10) Pub. No.: US 2019/0197863 A1
(43) Pub. Date: Jun. 27, 2019

(54) WareAbouts: Proactive Care System through Enhanced Awareness

(71) Applicant: Frank Kao, Palo Alto, CA (US)

(72) Inventor: Frank Kao, Palo Alto, CA (US)

(21) Appl. No.: 15/850,137

(22) Filed: Dec. 21, 2017

(51) Int. Cl. G08B 21/04; G08B 21/02

(52) U.S. Cl. CPC G08B 21/0423; G08B 21/0227; G08B 21/0272; G08B 21/0277; G08B 21/0415; G08B 21/0236; G08B 21/0233; G08B 21/0261; G08B 21/0294; G08B 21/0288

(57) ABSTRACT

A method that uses personalized “Awareness” rules created from IoT sensor data to reduce the burden of vigilant monitoring and enhances the caregiver's awareness on the on-going activities of the person-under-care to improve their Quality of Life by ensuring their safety, positive surroundings and provide needed timely proactive attention.

This method interprets data collected from all the location sensor nodes; made of old mobile phones which detect low-energy bluetooth signals within its proximity; and raises attention to the caregiver when anomalies from these rules are detected.

WareAbouts, an apparatus that uses the disclosed method to realize the invention's objective of protecting wandering individuals, reduce caregiver burden, improve elder's Quality of Life with least amount of caregiver intrusion.

### FIELD OF THE DISCLOSURE

The subject disclosure relates to an Internet-of-Things (IoT) platform and methods used to reduce caregiver burden when caring for aging elder to protect against wandering and ensure personal and emotional safety.

### BACKGROUND

The US population is aging rapidly. As one ages, the prevalence of diseases and chronic conditions common in the aging process increases at an alarming rate. The progressive nature of chronic diseases and the rapid decline of cognitive functions adds hitherto unseen conditions makes caring increasingly difficult day by day. The vigilant caring needs created heavy and stressful demands that caused adverse mental, physical health consequences among family members and caregivers. Despite great effort and sacrifices, the current caring solutions are extremely labor intensive and does NOT:
a) Provide around-the-clock systematically caring for the seniors
b) Systematically protect against the Wandering conditions of aging individuals with dementia by providing early warnings and detailed documentations before and after such activities
c) Ensure consistent coverage and standard documentations during incidences and for transitions between caregivers

The present disclosure presents a method of using “Individual Awareness Parameters” (or iAP); a form of “Business Rules” to represent the well-being and on-going activities of each individual and uses the “Awareness Rule Engine” to determine the current status of the individual and alerts the caregiver to provide immediate care.

The present disclosure also presents an apparatus, WareAbouts, that evaluates each individual's Awareness Parameters (iAP) in real-time against their customized “Peace Time Awareness Parameters” (or PTAp) to enhance the caregiver's awareness of the individual under care and reduces their burden of caring.

### BRIEF DESCRIPTION OF DRAWINGS

FIG. 1: WareAbouts Sensor Node BLE Device Tracking, components overview

FIG. 2: Awareness Parameters Format and Definition

FIG. 3: Peace Time Awareness Parameters Format and Definition

FIG. 4: Awareness Platform Components Architecture & Overview

FIG. 5: WareAbouts OnBoarding Process—Graphical User Interface (GUI)

5a: Binding Process

5b: Define “Peace Time Awareness Process”

FIG. 6: Peace Time Awareness Rules DataBase Schema

FIG. 7: Awareness Rule Engine

FIG. 8: Awareness Rules

8a: Activity, Interaction, Sound, Crowdedness

8b: Geo-Zone

FIG. 9: Individual Zone Device Mapping

### DETAILED DESCRIPTION

One or more embodiments are now described with reference to the drawings, wherein like reference numerals are used to refer to like elements throughout. In the following description, for purposes of explanation, numerous specific details are set forth in order to provide a thorough understanding of the various embodiments. It may be evident, however, that the various embodiments can be practiced without these specific details, e.g., without applying to any particular networked environment, database engines and database techniques, or use of different devices or standard. In other instances, well-known structures and devices are shown in block diagram form in order to facilitate describing the embodiments in additional detail.

As used in this application, the terms “component,” “module,” “system,” “node,” “platform,” “server,” or the like are generally intended to refer to a computer-related entity, either hardware, a combination of hardware and software, software, or software in execution or an entity related to an operational machine with one or more specific functionalities. The computer-related entity can be but not limited to computer or cloud server or computing devices such as the mobile phone. For example, a component may be, but is not limited to being, a process running on a processor, a processor, an object, an executable, a thread of execution, computer-executable instruction(s), a program, and/or a computer. By way of illustration, both an application running on a controller and the controller can be a component. One or more components may reside within a process and/or thread of execution and a component may be localized on one computer and/or distributed between two or more computers. As another example, an interface can include input/output (I/O) components as well as associated processor, application, and/or API components.

Furthermore, the various embodiments can be implemented as a method, apparatus, or article of manufacture using standard programming and/or engineering techniques to produce software, firmware, hardware, or any combination thereof to control a computer to implement one or more aspects of the disclosed subject matter. An article of manufacture can encompass a computer program accessible from any computer-readable device or computer-readable storage/communications media. For example, computer readable storage media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Of course, those skilled in the art will recognize many modifications can be made to this configuration without departing from the scope or spirit of the various embodiments.

Moreover, terms like “mobile device,” “mobile display device”, “mobile computing device” and similar terminology, refer to a wired or wireless communication-capable device utilized by a subscriber or user of a wired or wireless communication service to receive or convey data, control, voice, video, sound, gaming, or substantially any data-stream or signaling-stream. The foregoing terms are utilized interchangeably in the subject specification and related drawings. Data and signaling streams can be packetized or frame-based flows. Aspects or features of the disclosed subject matter can be exploited in substantially any wired or wireless communication technology; e.g., Universal Mobile Telecommunications System (UMTS), WiFi, Worldwide Interoperability for Microwave Access (WiMAX), Bluetooth, Low-Energy Bluetooth (BLE), Long Term Evolution (LTE), Third Generation Partnership Project 2 (3GPP2) Ultra Mobile Broadband (UMB), High Speed Packet Access (HSPA), ZigBee, or another IEEE 802.XX technology, Fifth generation (5G), etc. Additionally, substantially all aspects of the disclosed subject matter can be exploited in legacy (e.g., wireline) telecommunication technologies.

It should also be noted that throughout the present disclosure, the terms, BLE, low-energy bluetooth and bluetooth devices are used interchangeably to denote a device capable of transmitting and receiving bluetooth signals specified by the standard bluetooth and low-energy bluetooth specification. The term “tracking device” refers to these wearable bluetooth low-energy devices.

It should be noted that the term “proximity” refers to the signal detection or transmission range of the devices. For example, per specification, bluetooth devices have a signal range of 100 meter, whereas BLE devices have a signal transmission and detection range of 10 meters.

It should also be noted that the difference between the terms “sensed” versus “detected” used throughout the present disclosure. This is due to the nature of bluetooth signal interference issues, causing bluetooth signal to be unreliable to be used as detection source; wherein the term “sensed” may indicate the “potential presence” of a BLE device and the term “detected” means a “positive determination” of the presence of a BLE device within the detection range.

Furthermore, the terms “tracking devices,” “individuals under care,” “persons under care,” and the likes are employed interchangeably throughout the subject specification, unless context warrants particular distinction(s) among the terms. These terms refer to human entities or objects being tracked for their presence and activities.

It should be noted that “Individual Awareness Parameters” (iAP), and “Peace Time Awareness Parameters” (PTAp) are business rules created for the purpose of caregiving and refers to normalized, computer representation of each individual's well-being, location, and on-going activities.

It should be noted that this disclosure expands the meaning of the term “well-being” to beyond referring only to the individual's comfort, health and happiness to include personal safety, the condition of the immediate surrounding environment, persons of no objections within the immediate proximity, and the mental and emotional state of the person.

It should be noted that throughout the present disclosure, the term “location” refers to a position within the premise that can be either indoors or outdoors. The premise is defined as areas within the control of the administrator or management or owner of the facility or site.

It should be noted that the term “check-in patrol” refers to the “regular time interval patrol” practice at caregiving facilities such as nursing homes, assisted living facilities that performs a periodic visit and visual check on the individual to ensure their well-being. For example, it is common at assisted living facilities where the facility staff perform regular visual checks on the residents on an hourly basis.

It should be noted that the term “time-segment” refers to a certain time period with a defined duration not necessary based on the standard hour or at the start of each hour. For example, the “Morning” segment may be 4 hours long starting at 8:15 am and ending at 12:15 pm.

It should be noted that throughout the present disclosure the term “WareAbouts” stands for “awareness” of the on-going “abouts” or activities and surrounding environment and conditions of the individual under care.

Additionally, the term “Sensor Node” used throughout the present disclosure refers to mobile computing devices with capabilities to scan and sense the presence of tracking devices within its proximity. The “Sensor Node” then use its onboard communication component to wirelessly transmits the sensed data to the server for processing to determine the location of the device. In the current embodiment, bluetooth scanning technology is used to scan for BLE based tracking devices and the wireless WiFi networking technology is used to connect to the cloud server. However, various embodiments can substantially exploit this aspect using other sensing and tracking technologies, and with different wireless and wireline networking technologies.

It should be noted that all the Sensor Nodes are from the same brand and model devices with the same BLE onboard sensing component yielding similar signal strength while sensing for BLE devices within its proximity. The present disclosure, the Sensor Nodes are old Android Smart Phones running android OS version 4.4 codename KitKat. In other embodiments, later version of the hardware and android OS versions, or mixed android phone brands and models may be used.

It should be noted that the terms “individual Awareness Parameters” as iAP and the “Peace Time Awareness Parameters” as PTAp are used interchangeably throughout this disclosure.

The present disclosure presents a dataset transformation method that transforms the raw BLE sensed data into iAPs, and correlate against PTAp; which is created by combining the iAP and other environmental and the individual's BIO data for every time-segment of the day; to determine the state of the on-going activities and well-being of the individual.

“Individual Awareness Parameters” or iAP, are the computer-formatted “business rule” representation of each individual. In the current embodiment, these parameters are generated from the raw BLE device data. Other embodiments can exploit this feature by using similar data or the individual's bio-data from other devices that use other scanning and detection technologies.

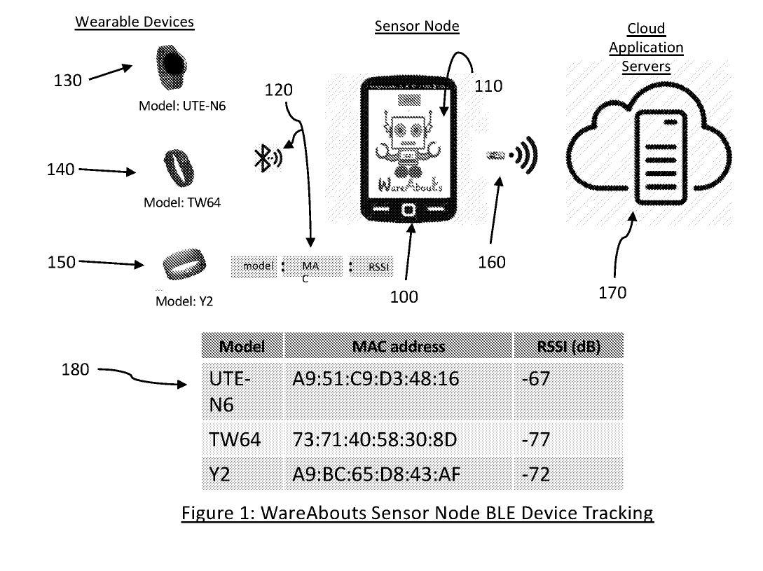

FIG. 1 illustrates the hardware and software components and the datasets used to generate the iAPs. Referring to FIG. 1, the Sensor Node denoted by element 100; is an old android smart phone with bluetooth scanning capability and running android OS version 4.4 or later; executing an application 110 that performs continuous bluetooth device scanning. Referring to element 180, illustrates the format of the sensed dataset that contained the set of BLE devices that have been “sensed”. Referring to elements 130, 140 and 150 are BLE devices within the proximity of Sensor Node. Each Sensor Node performs a continuous scan of the BLE devices; using bluetooth technology denoted by 120, within its proximity; and sends the data to the server at constant interval using WiFi component denoted by element 160. Element 170 is the cloud application server that receives the transmission and perform the dataset transformation to iAP. In the current embodiment a time interval of 15 secs is used for detecting BLE devices and sending the data to backend application servers, however, this aspect can be exploited to using another time interval based on the device technology used. The iAP is determined from the raw sensed datasets received from each Sensor Node.

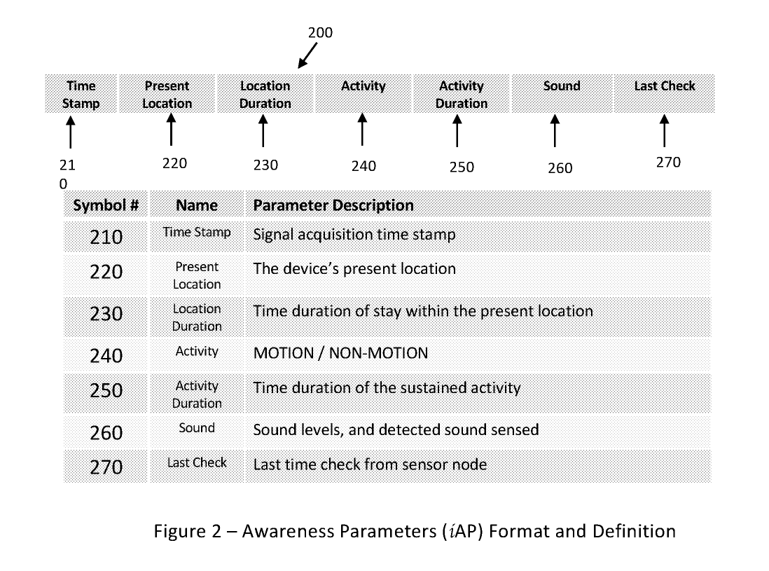

FIG. 2 illustrates the details of the iAP; wherein these parameters are determined in real-time, and represents each individual's on-going activities. The individual's iAP is determined from datasets from the current and prior transmissions from the Sensor Node. For example, in order to compensate for the inconsistencies of low-energy bluetooth signals, multiple datasets are needed to ensure that the correctness of the present location determined.

In the current embodiment, the Awareness Parameters may include but not limit each individual's a) current time (element 210); the time stamp of the signal acquisition, b) present location (element 220); c) time duration of stay within the location (element 230), c) activity, the individual's activity status (element 240), d) activity duration (element 250), time duration of the sustained activity of the activity, e) sound (element 260), sound levels measured in decibels, and any detected sound events in the immediate environment, and f) last time check (element 270) on receiving data. Other embodiments may use tracking device that can access individual's bio data such as using heart rate, number of steps, blood pressure as activity, motion or using tracking devices equipped with GPS data.

The PTAp, consists of a range of values that represents each individual's normal condition, or “Peace Time”, for the specified time segment. The “Awareness Rule Engine” application server computes the individual's live iAP in real-time and correlates against the individual's “PTAp” for the same time period. The caregiver is alerted when deviation or anomaly is detected.

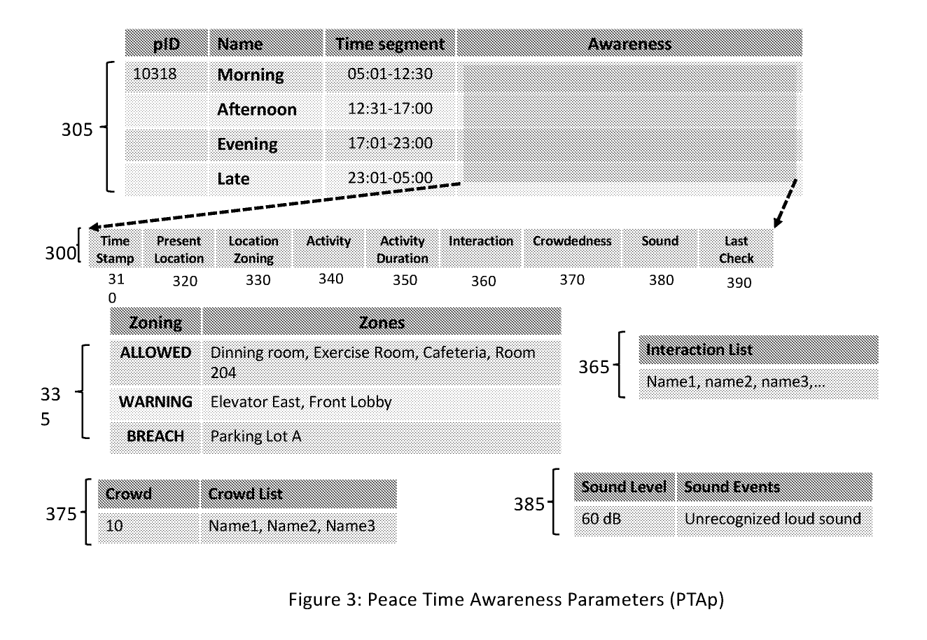

Referring to FIG. 3, element 300, is the data structure of the PTAp. Referring to FIG. 3, element 305 denotes the individual time-segments defined for the PTAp—element 300. All these time-segments combined covers the entire 24-hours of the day, and each segment is uniquely specified with a “name” and uniquely associated with an ID (pID).

Referring to FIG. 3, element 335 is the location zoning or geo-fence for each individual. Each Sensor Node is assigned a unique ID and associated to a unique physical location. “Zoning”; combines different premise locations into “classified zone lists” or a list of Sensor Node IDs, that varies for different time-segments. The zones are classified as “ALLOWED”, “WARNING” and “BREACH”. For any given time-segment, “ALLOWED” zones are areas that the individual is allowed to be in; wherein “WARNING” zones are areas that individual can stay in for a certain period of time; and “BREACH” zones are areas the individual cannot be there for any given period of time. Zone duration timers are specified for each of these zones, and proper alert (ALLOWED, WARNING, BREACH) generated to raise caregiver attention.

Zones are specified specifically for a certain time-segment and can be customized by adding or deleting locations for each. In other embodiments, classification of these zones into additional or less criteria and shorter or longer time segments or reoccurrence based on calendar schedule such as weekly, monthly or even yearly maybe possible.

Referring to FIG. 3, and elements 305, and 335. “Zoning”, created a time-based geo-fencing for the individual that covers the entire 24-hour of the day.

The “Interaction” parameter is used to ensure that there are no unwanted exposures to individuals or objects. Referring to FIG. 3, and element 365, the interaction parameter is an ID list of unwanted individuals and objects for a given time segment. In the current embodiment, an interaction duration of 5 minutes or more triggers caregiver alert, however, this duration timer can be modified in other embodiments.

The “Crowdedness” parameter is the number of individuals detected within the same proximity and it is a measure of the quality of the individual's immediate surrounding environment. Referring to FIG. 3, element 370 and 375; the “Crowdedness” parameter is a list of the BLE devices sensed. For example, presence detected for large number of individuals indicates a noisy and confusing environment. In other embodiments, the parameter can be expanded to include list of the individuals and objects sensed within the same proximity.

The “Sound” parameter is the sound level, and any detected “sound events” within the same proximity, and it is also a measure of the quality of the individual's immediate surrounding environment. Referring to FIG. 3, element 380 and 385; the “Sound” parameter is the reading of the sound level measured in decibels in the immediate environment along with any detected sound events. Sound detection events can be just “sudden loud noises” or “cries for help” from sounding sensing applications. In other embodiments, sound sensing application may exploit this feature by adding sound sensing applications that detect specific sounds within the environment.

The present disclosure discloses “WareAbouts”, an apparatus that uses the iAP and PTAp to assist the caregiver to monitor the individuals under care.

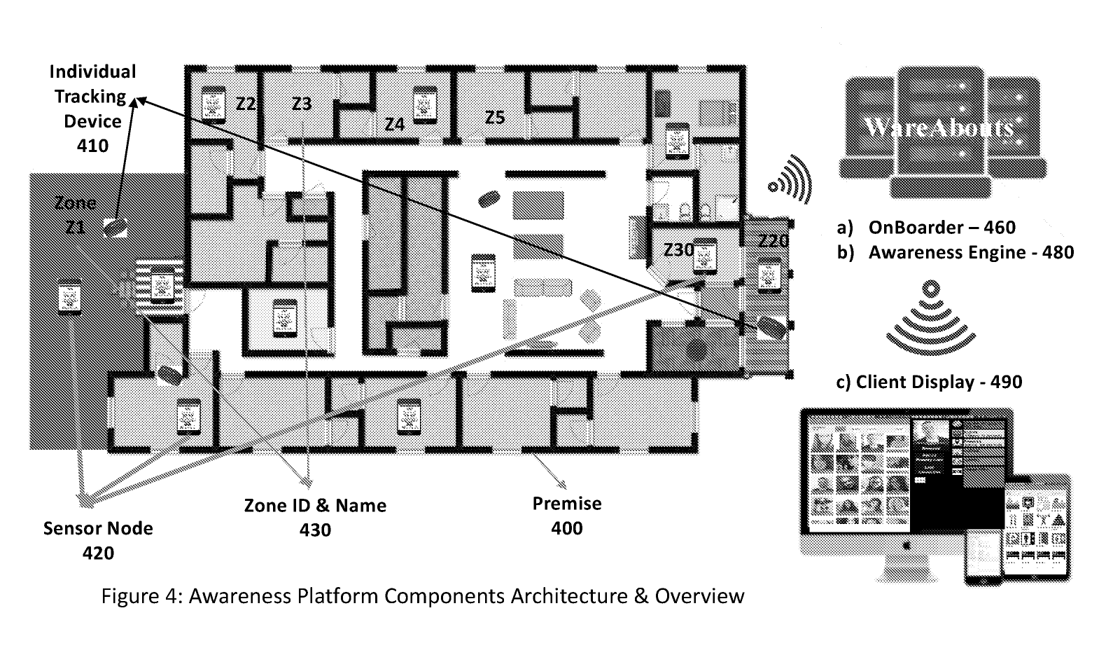

FIG. 4 details the architecture and the hardware and software components of the WareAbouts Platform. Referring to FIG. 4, the entire premise (element 400); regardless of indoor or outdoor, to include each room, floor, common areas, buildings entrances, exits, and outdoor garden areas; are divided into “zones”; wherein each “zone” is assigned a unique “Zone ID” and a unique “Zone Name” that can be referenced by computer software (element 430). At least one bluetooth based Sensor Nodes (element 420) are placed in each of the zones. Element 410 are wearable BLE devices worn by individuals roaming freely within the premise 400.

In the current embodiment, the Sensor Nodes (element 420) are old android smart phones running an application that scan continuously for BLE devices and sends the sensed data to the cloud application servers (element 460 and 480) in a 15 sec constant time interval. In another embodiment may exploit features such using other none android based smart phones or none-bluetooth based scanning and detecting technologies and a different data transmission time interval.

Referring to FIG. 4, display clients (element 490) displays the results of the application servers to the administrator or caregivers to configure the PTAp as well as other administrative features to include but not limited to profile and bind devices to individuals and zones. Display clients (element 490) also displays the current well-being status of the individual and notifies the caregiver in the case of anomalies. In the current embodiment, desktop computing client and displays or mobile computing device displays using either wireline or wireless technology are used.

In other embodiments, depending on the product features of the wearable device and local regulations; additional individual's BIO-based data items such as number of footsteps, heart rate, GPS and other items available in the wearable device maybe used. Referring to FIG. 4, due to the transmission and reception range of the bluetooth and BLE devices (10-100 m), the same tracking device worn by the individual may be sensed by several different Sensor Node.

Referring to FIG. 4, personal wearable BLE devices (element 410) are tracking devices worn by individuals to include but not limited to Fitbit, iWatch, badge, pendant, jewelry and clothing. These BLE devices have a signal broadcasting range of 10 meters per bluetooth low-energy specification. This feature may be exploited by other embodiments by using a different technology with a different sensing and proximity range.

Referring to FIG. 4, the cloud application contains two application servers: a) OnBoarder (element 460) and the b) Awareness Rule Engine (element 480). In another embodiment, more or less than two application servers may be used. These application servers receive datasets from Sensor Nodes, convert them to iAP, correlates against the individual's PTAp for the given time segment and alerts the caregiver if anomalies are detected.

Referring to FIG. 4, OnBoarder (element 460), is the application server that generates and maintains the PTAp for each individual.

The OnBoarder server (element 460) also maintains the profiles and keep track of the premise locations, Sensor Nodes, wearable moving and none-moving tracking devices, and individuals; wherein unique ID is assigned to each and stored and managed.

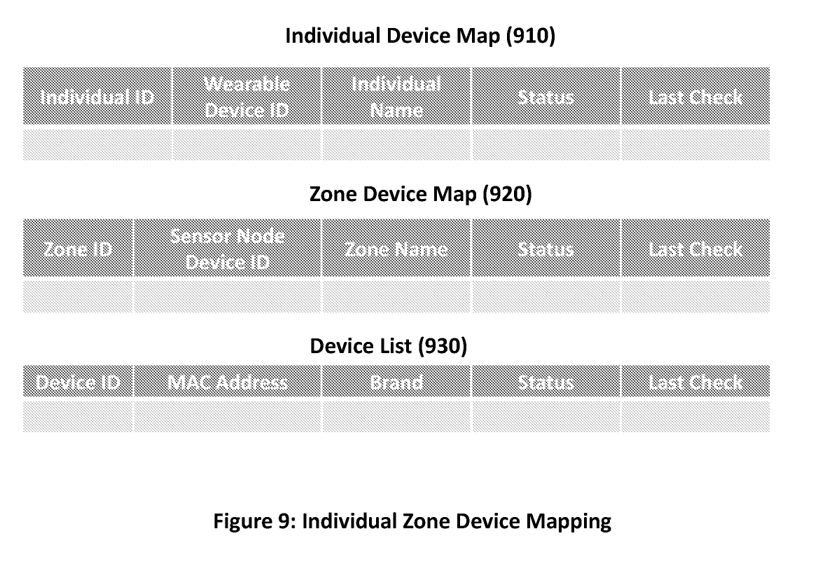

Referring to FIG. 9, the entire premise area to include all indoor and outdoor locations; wherein the entire premise is divided into “zones” and each assigned a unique zone ID so that it can be referenced by application software. The “Zone Device Map” (920) database table fields: “Zone ID” and “Zone Name” denotes the one-to-one mapping of each zone to a unique ID.

Referring to FIG. 9, The OnBoarder application server (element 460) maintains the database table “Individual Device Map” (910) denotes the one-to-one mapping of each individual to a unique tracking device worn by the individual.

Referring to FIG. 9, the database table “Zone Device Map” (920) denotes the one-to-one mapping of each zone to a Sensor Node device. Each zone is assigned and associated with a unique “zone ID” and mapped to a unique sensor device ID listed in database table—Device List table (930).

In the current embodiment, the OnBoarder (element 460) also maintains the database table that contains the one-to-one mapping of the ID of the Sensor Nodes to each physical location on the premise. The location can be either indoor and outdoor. Each Sensor Node is specified with a unique Sensor ID. Each location is specified with a unique Zone ID.

The WareAbouts Platform then undergoes a “BIND” process that associates:
a) A wearable device to an individual
b) Assigning a default “zone” to an individual, or a default area or room where the individual normally resides
c) Assign a Sensor Node device to a zone
d) Most importantly, define a PTAp to an individual

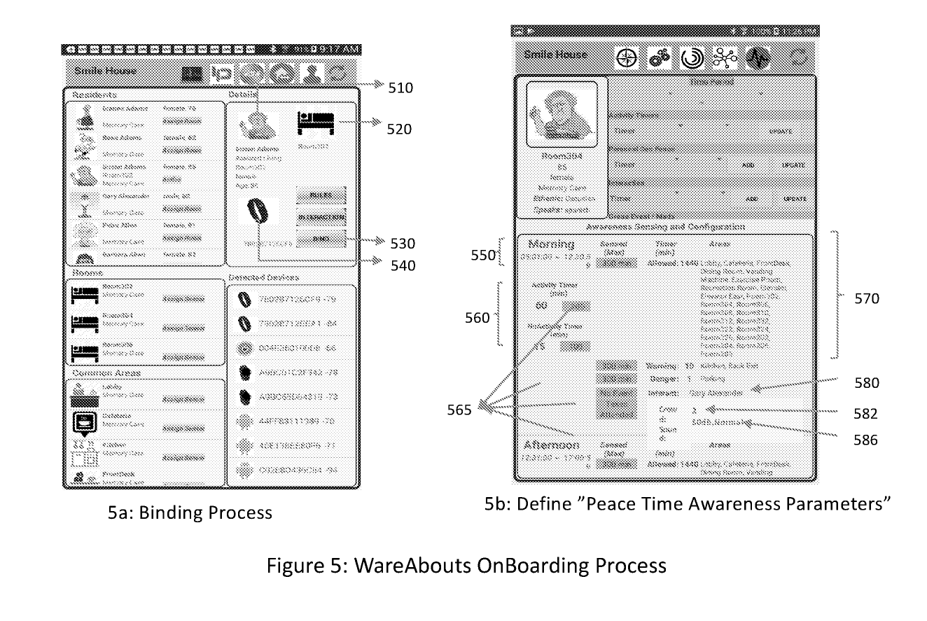

Referring to FIG. 5A and FIG. 5B illustrates the Graphical User Interface (GUI) used to that bind individual, device, and zone together, and subsequently configures the PTAp for each individual. The individual (element 510), the default home location or room (element 520), and the tracking device worn (element 530) must all be selected or defined before the binding process can be successfully completed. Pressing the “BIND” button (element 530) initiates and completes the bind process if there were no errors. The OnBoarder associates the ID of the individual, his/her default room assignment, and the ID of the tracking device together.

Referring to FIG. 5B, illustrates the client display GUI to define and configure each individual's PTAp for every time-segments in a day. In the current embodiment, element 550, is a basic awareness template of breaking the 24-hour day into four time segments; Morning, Afternoon, Evening, and Late. In another embodiment additional and lesser time segments may be used.

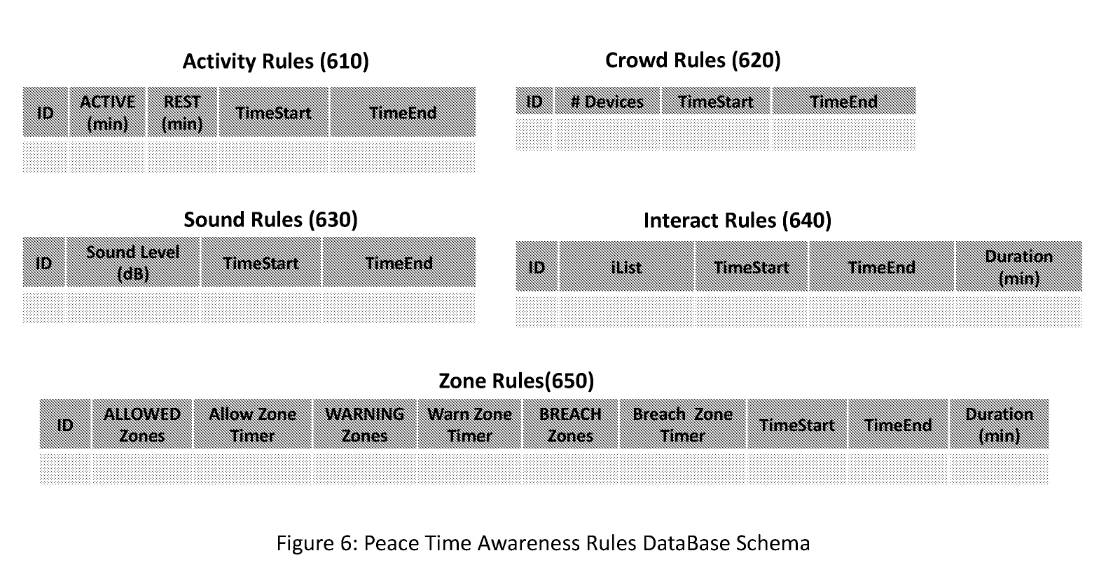

The OnBoarder application server maintains a database table that specifies the PTAp value ranges for every time segments of the day for every individual in the facility. Referring to FIG. 6 illustrate the detail database schema of the PTAp and contains the rule tables: Activity (610), Crowd (620), Sound (630), Interact (640) and the Zone (650).

Referring to FIG. 6, time segment refers to the time period enclosed by the TimeStart and TimeEnd parameter which are defined in the rule tables (610, 620, 630, 640, and 650). For example, a “TimeStart” of 05:00 and “TimeEnd” of 12:30 refers to the time period of 5 am to 12:30 pm.

Referring to FIG. 6; illustrates the Activity Rules table (610), wherein each individual's resting, and activity timers (specified in minutes), are denoted by the fields: REST, and ACTIVE for the time period specified by the TimeStart and TimeEnd parameter. For example, during the time period 5 am to 12:30 pm, the individual's normal activity pattern is 30 min resting or REST=30, and active of 20 min or ACTIVE=20, with a TimeStart=“05:00” and TimeEnd=“12:30”.

Referring to FIG. 6; illustrates the Crowd Rules table (620), which specifies the maximum number of individuals or detected devices that can be in the same proximity. For example, setting field “# Devices=5”, “TimeStart=05:00” and “TimeEnd=12:30” indicates for the time period of 5 am to 12:30 pm, the maximum number devices or individuals that can be within the same proximity is limited to 5. Caregiver is alerted if more than 5 devices are detected.

Referring to FIG. 6 illustrates the Sound Rules table (630), which restricts the maximum allowed sound level (in decibels) within the individual's proximity during the specified time segment. For example, “Sound Level=90”, with TimeStart=“05:00” and “TimeEnd=12:30”, limits the maximum sound dB level within the proximity of the specific individual defined by ID for time the time period 5:00 am to 12:30 pm.

Referring to FIG. 6, illustrates the Interact Rules table (640) wherein defines the list of unwanted individuals within the proximity of the individual. For example, an “iList=10,15,17”, “TimeStart=05:00” and “TimeEnd=12:30” indicates that if any of the individuals with IDs in the “iList” is detected for the time period 5 am to 12:30 pm, an Interaction Alert is generated.

Referring to FIG. 6; illustrates the Zone Rules table (650), wherein defines the list of zones specified based on the geo-fence defined for the individual for the time period specified. Referring to table fields: ALLOWED, WARNING, and BREACH; wherein each field contain a list of zone IDs. The three zone classification together defines a “Geo-Fence”, or a list of premise areas that can and cannot be accessed, or an area that can lead to danger for the individual during the specified time period. A “duration timer” or “length of stay” timer is associated with each zone; a zone alert is generated if the individual stay beyond the timer specified. For example, for the same time period 5 am to 12:30 pm, “ALLOWED=2,7,10,12”, ALLOWED TIME=″1440″, “WARNING=5,8”, “WARNING TIME=7”, and “BREACH=10,15”, “BREACH TIME=1”, where zone IDs; 2=ROOM 218, 7=Dining Room, 10=Garden, 12=Game Room (Allowed Areas) with duration of 1440 minutes, 5=Lobby, 8=Elevator (Warning Areas) duration 7 minutes, and 10=Parking Lot, 15=Front Gate (Breach Areas) with duration of 1 minute. For this example, the individual can stay in the allowed area for up to 1440 minutes or 24 hours, and allowed to stay in the warning areas for up to 7 minutes, and 1 min in the breach or danger areas. A zone alert is generated if the timer duration expired for any of the duration specified.

Referring to FIG. 5, illustrates the client display GUI that configures the “Zoning” function (element 570) by combining different locations into “Zones” and classify these zones into categories: ALLOWED, WARNING and BREACH. In other embodiments, additional or less classifications can be applied to these locations. The zoning classifications represents a personalized time-varying geo-fencing feature.

In the current embodiment, the “Activity” (element 560), “Interaction” (element 580), “Crowdedness” (element 582), and “Sound” (element 586) are defined thru the spinner selections at the top of the GUI.

In the current embodiment, tracking results are also display in element 565 for each of the PTAp to allow adjustments, and business rules changes.

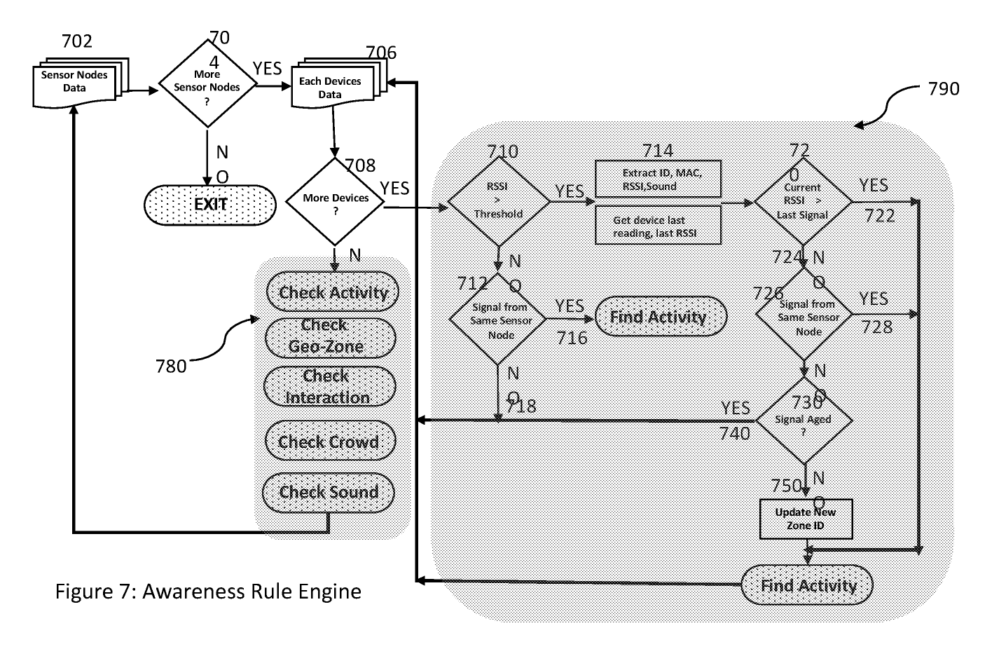

Referring to FIG. 7, illustrates the programming logic of the “Awareness Rule Engine”; a cloud application server that converts Sensor Nodes' BLE sensed data into iAP denoted by element 790; performs business rule correlation against the PTAp to raise proper alerts for the different conditions, denoted by element 780.

Referring to FIG. 4, element 490; wherein the client display devices can be desktop computers, iPads or any android based computing devices. The caregiver is alerted via SMS text, or GUI display to these display devices when anomalies are detected for:
a) Zoning, and the individual's stay duration within the zone,
b) Activity, and the individual's duration of performing this activity
c) Interaction, any unwanted individuals or objects within proximity range
d) Crowdedness, number of other individuals within proximity range
e) Sound level, and any sound anomaly event detected within proximity range

Referring to FIG. 7 and element 702; are sensed device datasets from the Sensor Nodes. These datasets are being sent from the Sensor Nodes and received by the “Awareness Rules Engine” (FIG. 4, element 480) at a time interval of 15 sec. Each dataset contains all the devices that the Sensor Node sensed within its proximity, as denoted in element 706.

Referring to FIG. 7, element 790; incoming raw sensed data are processed to ensure the accuracy and position of the tracking device. Element 790 presents an algorithm that process, varying strength signals; multiple detection of the same device by multiple sensor nodes; and guard against the inconsistencies and interruptions of signal transmission and reception of BLE devices.

Referring to FIG. 7, considers the case of a signal strength that decreased since last signal reading; movement away from the previously determined present location's Sensor Node, and being sensed by another Sensor Node. Elements 710, and 712 considers the case of a weak signal whose threshold is either pre-configured based on 6-meter distance radius per Sensor Node's specification. In another embodiment, the signal threshold can be determine using algorithm to examine prior detected signal strength. The signal is processed only if it is detected by the same Sensor Node previously; indicating device movement (element 716); otherwise, the signal is discarded; indicating that a false or reflected detection from a remote Sensor Node (element 718).

Referring to FIG. 7, elements 720, 726, and 730; considers the case for sufficient strength BLE signals for device movements or to compensate for the inconsistencies of BLE signals. As denoted by elements 722, and 728; Signals are processed only if the BLE signals are stronger than previously detected, or if the signal is detected by the same Sensor Node.

Referring to FIG. 7, element 730; considers the case of “Aged Signals”; Sensor Node's failure to sense BLE devices caused by hardware component failures or from environmental interference which can last from one or two transmission intervals of 15 seconds, or multiple minutes. Referring to element 750; in the case of “Aged Signal”, the current signal regardless of signal strength is considered to be the latest valid signal and its Sensor Node ID represents the present location of the tracking device.

Element 740, considers the case that there are no gaps in the datasets, and the current detected signal is detected by another Sensor Node; and its signal strength is weaker than the previously detected signal; the detected signal is considered a reflected signal detected by another Sensor Node and discarded.

Referring to FIG. 7, element 706; For the device dataset that have been discarded, the next device in 706's dataset list is processed. For the others which are considered valid device data, the device's dataset is converted into iAP and matched against PTAp for anomalies.

Referring to FIG. 7, element 780; Once all the sensed devices have been processed for a single Sensor Nodes; Awareness Parameters; Interaction, Crowd, and Sound are computed for the individual wearing the device.

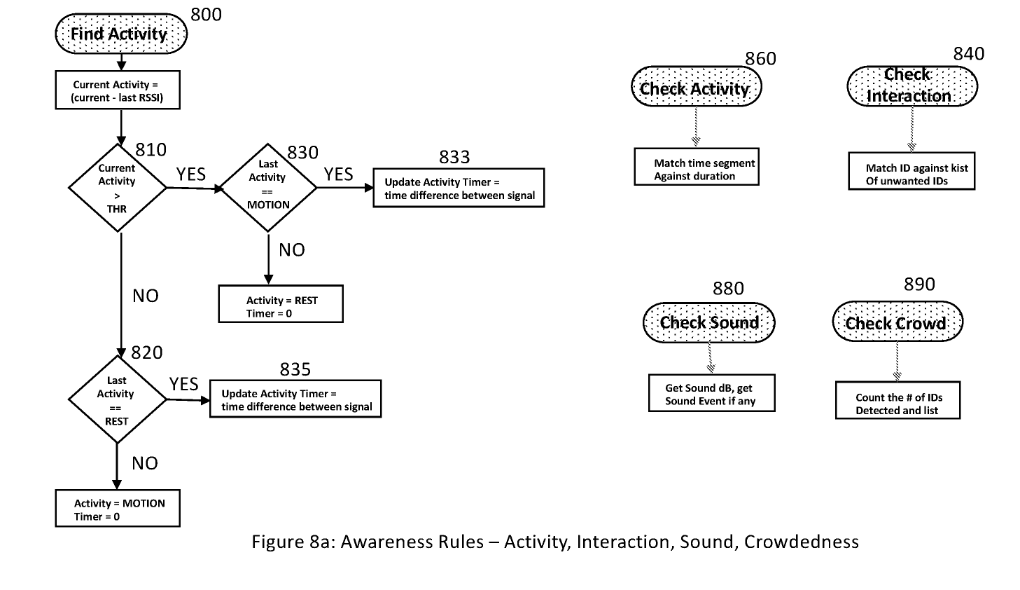

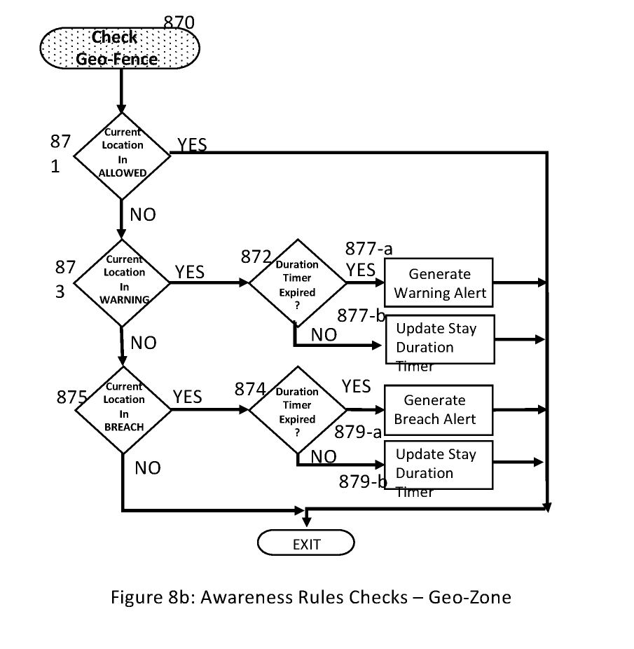

FIG. 8a and FIG. 8b, presents the programming logic to correlate the iAP against the individual's PTAp and elements 800, 840, 860, 870, and 880 denotes the individual PTAp rules processing algorithms.

Referring to FIG. 8, and element 800; computes the Activity, and Activity Duration parameter of the iAP. Elements 810, and 820 determines the individual's activity by comparing its signal strength against previously detected signal. “Activity Status” is determined by checking signal strength variations against its last reading; wherein variation indicates motion, no motion or at rest otherwise. Duration timer is incremented if the “Activity Status” is the same as the last status determined, otherwise it is reset due to a change of activity status. Referring to FIG. 8, elements 810, and 830 are cases when a prior MOTION status is compared against a newly determined “motion” status, its duration timer is updated with the time difference as specified in element 833. Element 835 is the case wherein the prior status is REST and its duration reset.

Referring to FIG. 8a; elements 840, 860, 880, and 890 are the programming logic used to correlate the iAP against the PTAp's Activity, Geo-Fence, Interaction, Crowded and Sound rules. Referring to FIG. 8b; element 870 represents the programming logic for Geo-Fence rule. Referring to element 860, the “Activity” parameter can be either MOTION, or REST and their computed duration are normal database field comparison against the PTAp for the same activity status and activity duration. Anomaly alert is raised if activity duration falls out of range of the particular activity.

Referring to FIG. 8a, element 840 which processes the “Interact” algorithm wherein detected individuals are matched against the unwanted list in the PTAp; caregiver alert is generated if found. Elements 840, performs database field matching of the device ID against the list of IDs in the PTAp.

Referring to FIG. 8a, element 890 which presents the “Crowdedness” algorithm wherein the number detected individuals is correlated against the PTAp's “Crowdedness” parameter, and the “Crowdedness” alert generated if the parameter exceeded the one specified in PTAp.

Referring to FIG. 8a, Element 880; presents the “Sound” algorithm wherein the surrounding environment's sound level do not exceed to that specified in the individual's PTAp, otherwise the caregiver is alerted. In another embodiment, specialized “sound sensing” application executing in the Sensor Node may present “detected sound events” that may trigger caregiver alerts.

Referring to FIG. 8b, element 870, presets the “Geo-Fence” algorithm wherein the present location and the stay duration within the zone is within the normal range in the PTAp for the specified time segment. If the stay duration timer exceeds that of the configured value in the PTAp, the proper alarm is generated.

Referring to FIG. 8b, element 870, the present location is first checked if it is in the “ALLOWABLE” zone. No further alarms or stay duration timer check if the present location is in the ALLOWABLE zone as described by element 871.

Referring to FIG. 8b, elements 872, and 873 checks for present location that is in “WARNING” zone. An “Warning Zone” alert is generated (element 877-a) if the present location is in the Warning Zone, and the stay duration timer expired, otherwise, the stay duration timer in the warning zone is updated (element 877-b).

Referring to FIG. 8b, elements 874, and 875 checks for present location that is in “BREACH” zone. A “Breach Zone” alert is generated (element 879-a) if the present location is in the Breach Zone, and the stay duration timer expired, otherwise, the stay duration timer in the warning zone is updated (element 879-b).

The PTAp can be configured to generate alerts based on the perceived “intent” from examining individual's past behavior pattern records; or tweaking the PTAp parameters to alert caregiver to warn or interfere with the individual's on-going activity; or to predict the individual's future behavior and generate an early warning in order to provide proactive action. For example, the individual with “wandering risk” or with some degree of “cognitive impairment” frequents the “WARNING” zones such as the “stairs or elevators” and stays in those zones for a longer than expected time duration (5 min). The behavior can be determined that the individual is searching for means of exiting the facility. For this case, the zone duration timer can be tweaked down, and the warning zone can be switched to BREACH to generate early warning to the caregiver in case the individual wanders off the premise.

Another example would be the rapid decline of the individual's cognitive capacities that can cause unforeseen emotional outbursts or agitated responses and may lead to dangerous consequences. These conditions can be triggered by a noisy environment or come in contact with unwanted individuals. PTAp can be modified to compensate for this situation and caregiver is given an early warning to take proactive corrective action before the situation becomes uncontrollable.

Further derivation of Awareness Parameters such as activity and duration within certain zone (WARNING) plus other personal bio-parameters such as heart rate can also indicate Wandering behavior and used to generate early warning to caregiver to provide proactive corrective action.

What is claimed is:

1. A method that:
Uses “Individual Awareness Parameters” (iAP) to represent the well-being of each person-under-care, by
converting sensed presence of their wearable devices into “awareness parameters” (iAP); and
correlate against the “Peace-Time Awareness Parameters” (PTAp) to determine danger.

2. An apparatus comprised of:
Wearable BLE tracking devices worn by each person-under-care roaming freely;
Sensor Data Nodes placed at different locations; wherein each node senses for the presence of BLE signals within its proximity, and send the data to,
a processor; or cloud application servers that
registers and maintains the mappings of individuals, sensor nodes, their installed locations, and wearable tracking devices;
determines person's present location from data received from all the data nodes; wherein the location is determined from proximity sensing data from all the sensor nodes;
converts the received data into awareness parameters for each person, and
streams the awareness data to the caregiver, which constantly
displays the awareness status to the caregiver, and
in response to determination of correlation anomalies with the Peace Time Awareness Parameters, causes transmission of a message and changes the screen display to the display information associate with the person's location data, and awareness anomalies to caregiver.

3. The method of claim 1, wherein iAP is a computer-searchable normalized business rule representation of each individual's current well-being and the PTAp, represents the normal healthy and safe awareness parameter ranges of the individual for every time segment of the day.

4. The method of claim 1, wherein iAP include but not limited to: location, activity, duration of activity, number of individuals/objects within proximity, un-wanted interaction list, and last-check time.

5. The method of claim 1, wherein the PTAp creates a “time-varying geo-fence” allowing maximum roaming freedom with maximum personal privacy for any given time segment during the day.

6. The method of claim 1, wherein the PTAp location zoning, and activity duration combined provides insights to the individual's intent and allow caregiver to take “proactive actions” to mitigate the potential dangerous condition. For example, exceeding stay duration at the elevator; classified as WARNING zone; of a memory care unit may indicate intent of planning for an exit using the elevator.

7. The method of claim 1, wherein the combination of activity, and activity duration at any given time segment may indicate the health status of the individual, and may shorten caregiver response time from the normal patrol time. For example, if none motion time exceeds the specified in Peace Time Awareness Parameters, rather than waiting for caregiver's normal check-in patrol time, alert is raised for caregiver attention.

8. The apparatus of claim 2, wherein the iAP and the PTAp heightens the caregiver's awareness of the individuals current well-being status and allows for proactive measures to improve the individual's Quality of Life by ensuring no un-wanted and limited number of individuals and a peaceful and quiet environment.

9. The apparatus of claim 2, wherein the system can predict and provide early warning for Wandering behavior by adjusting the “Peace Time Awareness Parameters'” zone, and time duration.

10. The apparatus of claim 2, wherein the system triggers immediate Wandering alert when the individual is detected in the BREACH zone, or the individual's tracking device have not been heard from and not communicate with the server for a certain period of time. The current time is 1 minute.

11. The apparatus of claim 2, wherein the PTAp can be customized and extended to trigger specific caregiver alert.

12. The apparatus of claim 2, wherein the caregiver burden is reduced by using BLE sensing technology to enhance the caregiver's awareness in real-time to the individual's on-going activities in order to proactively provide timely needed care and attention. The

13. The apparatus of claim 2, wherein the system of Awareness Engine reduces caregiver's burden of vigilantly monitoring and provide timely updates, and early warning for wandering behaviors or any other “none normal” activities and behaviors.

14. The apparatus of claim 2, wherein the sensor nodes; are smart phones devices or devices that can execute an application that scans for bluetooth devices within its proximity range and communicate the result to the server via its wireless or wireline networking component.

15. The apparatus of claim 2, wherein the individual's Quality of Life is improved; where individuals can roam freely with their safety assured; caregiver alerted to provide needed timely proactive care; their surroundings controlled to ensure a positive environment; and are constantly monitored for an unforeseen events and medical conditions.

16. The system of claim 9, wherein the system protects the person-under-care with dementia and alerts caregiver as the person wander off the premise within 30 sec of departure with precise documentation of their exit location.

17. The system of claim 9, wherein the GUI can quickly provide an overview of the awareness status of the elder's well-being in terms of location safety, activity level and environmental factors.

18. The system of claim 9, wherein the system collects observations on the trending behavior of the individual and can be used to predict future behavior patterns in terms of activity, location and interaction.
